(19) United States
(12) Patent Application Publication
(10) Pub. No.: US 2024/0274964 A1
(43) Pub. Date: Aug. 15, 2024

(54) BUS-BAR MODULE

(71) Applicant: Yazaki Corporation, Tokyo (JP)

(72) Inventors: Kazuaki SAITO, Shizuoka (JP); Hiroyuki KATO, Shizuoka (JP); Hajime NAKATANI, Shizuoka (JP)

(73) Assignee: Yazaki Corporation, Tokyo (JP)

(21) Appl. No.: 18/643,665

(22) Filed: Apr. 23, 2024

Related U.S. Application Data
(63) Continuation of application No. PCT/JP2023/003497, filed on Feb. 3, 2023.

(30) Foreign Application Priority Data
Feb. 15, 2022 (JP) 2022-021345

(51) Int. Cl. H01M 50/298; H01M 50/507; H01M 50/588

(52) U.S. Cl. CPC H01M 50/298; H01M 50/507; H01M 50/588

(57) ABSTRACT

A bus-bar module include an electrical-wire routing body to be assembled with a battery module configured of plural battery cells, plural bus-bars that are stored in the electrical-wire routing body and are to be electrically connected between electrodes of the battery cells, respectively, and plural electrical-wires to be connected with the battery cells via the bus-bars. The electrical-wire routing body includes a pair of electrical-wire routing passages that are divided by a slit and in which the electrical-wires are routed. Each of the electrical-wire routing passages is provided with a pair of side walls. In at least one of the pair of electrical-wire routing passages that are divided by the slit, a cut-off is formed at an upper-end corner, which faces to the slit, of one of the pair of side walls.

### CROSS REFERENCE TO RELATED APPLICATION

The present application is a continuation of International Application No. PCT/JP2023/003497, filed on Feb. 3, 2023, and based upon and claims the benefit of priority from Japanese Patent Application No. 2022-21345, filed on Feb. 15, 2022, the entire contents of which are incorporated herein by reference.

### TECHNICAL FIELD

The present disclosure relates to a bus-bar module that is to be electrically connected with battery cells of a battery module by bus-bars.

### BACKGROUND

JP2018-195504A discloses a bus-bar module. This bus-bar module is assembled into a battery module. The bus-bar module includes an electrical-wire routing body that stores plural bus-bars connecting between electrodes of battery cells in the battery module, plural electrical wires connected to the battery cells via the bus-bars, and an electrical-wire routing groove formed in the electrical-wire routing body to store the electrical wires between a pair of side walls thereof. The electrical-wire routing body is divided by slits to absorb pitch tolerance (changes of aligning pitch of the battery cells due to thermal deformation, etc.) caused by charging and discharging of the battery module. The electrical wires connected to the bus-bars are drawn out to a space between the pair of side walls of the electrical-wire routing groove and routed in the space.

### SUMMARY OF THE INVENTION

However, when routing the electrical wire(s) between the pair of side walls of the electrical-wire routing groove in the bus-bar module disclosed in the above-mentioned JP2018-195504A, the electrical-wire gets into the slit formed in the side wall at an electrical-wire entry port of the electrical-wire routing groove, and thereby it takes time to route the electrical wire.

An object of the present disclosure is to provide a bus-bar module by which an electrical wire connected to a bus-bar can be routed quickly and smoothly without getting the electrical wire caught in a slit formed in a side wall of its electrical-wire routing passage.

A bus-bar module according to the present disclosure includes an electrical-wire routing body to be assembled with a battery module configured of a plurality of battery cells; a plurality of bus-bars that are stored in the electrical-wire routing body and are to be electrically connected between electrodes of the battery cells, respectively; and a plurality of electrical-wires to be connected with the battery cells via the bus-bars, wherein the electrical-wire routing body includes a pair of electrical-wire routing passages that are divided by a slit and in which the electrical-wires are routed, wherein each of the electrical-wire routing passages is provided with a pair of side walls, and wherein, in at least one of the pair of electrical-wire routing passages that are divided by the slit, a cut-off is formed at an upper-end corner of one of the pair of side walls, the upper-end corner facing to the slit.

According to the bus-bar module, provided can be the bus-bar module by which an electrical wire connected to a bus-bar can be routed quickly and smoothly without getting the electrical wire caught in a slit formed in a side wall of its electrical-wire routing passage.

### BRIEF DESCRIPTION OF DRAWINGS

FIG. 1 is a plan view of a bus-bar module according to an embodiment;

FIG. 2 is a perspective view of the bus-bar module;

FIG. 3 is a perspective view illustrating routing of an electrical-wire in the bus-bar module;

FIG. 4A is a schematic side view illustrating the routing of an electrical-wire in the bus-bar module;

FIG. 4B is a schematic side view illustrating routing of an electrical-wire in a bus-bar module according to another embodiment; and

FIG. 4C is a schematic side view illustrating routing of an electrical-wire in a bus-bar module according to a comparative example.

### DETAILED DESCRIPTION OF THE INVENTION

Hereinafter, a bus-bar module according to an embodiment will be described with reference to the drawings.

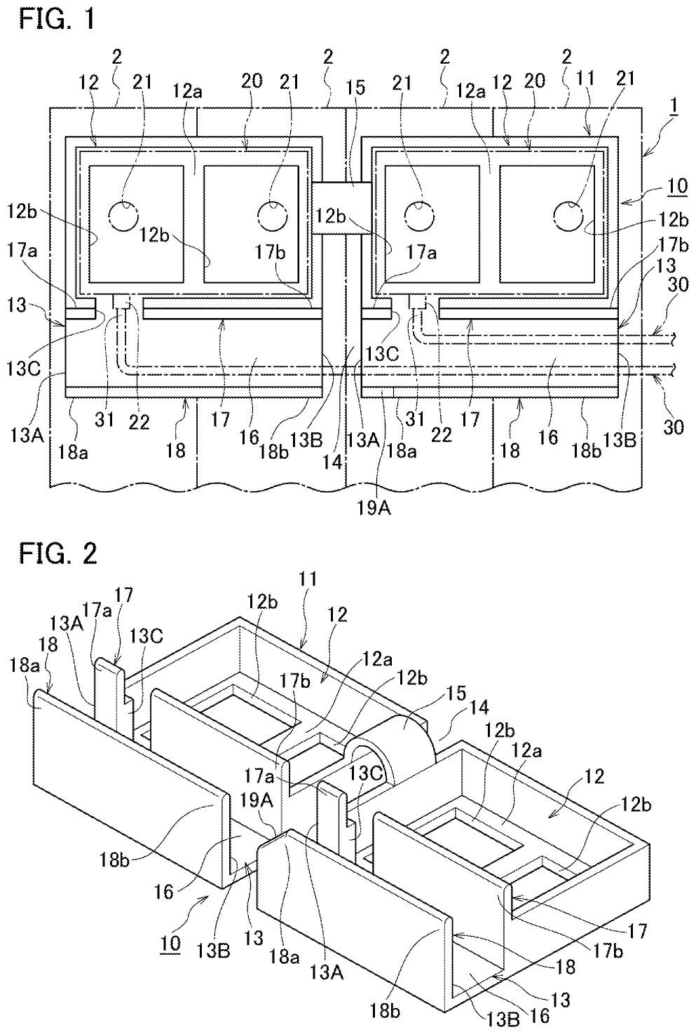

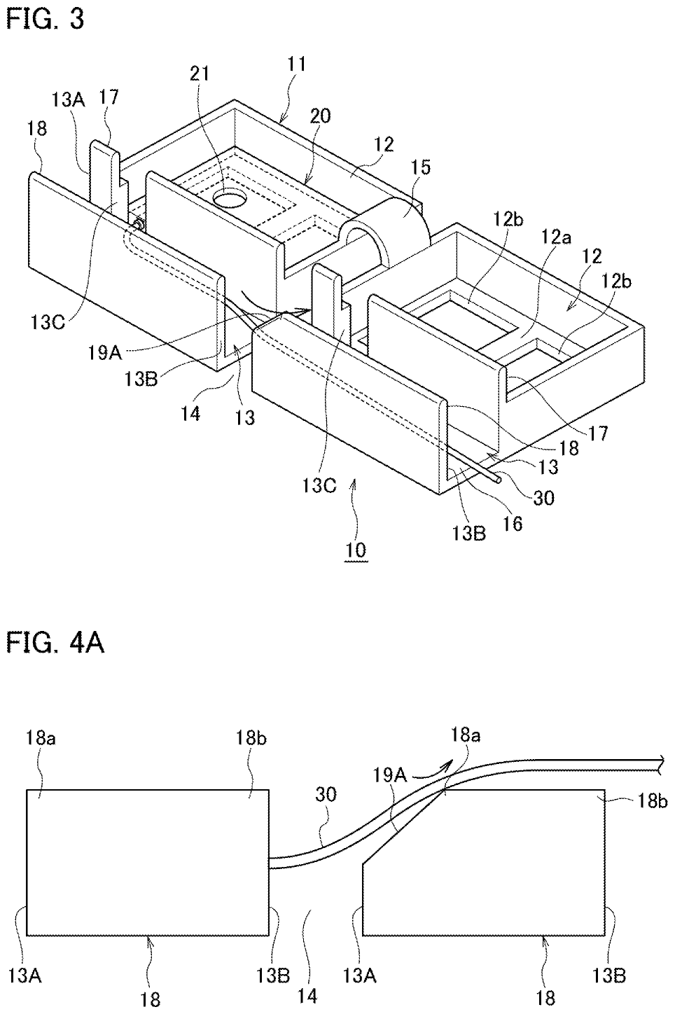

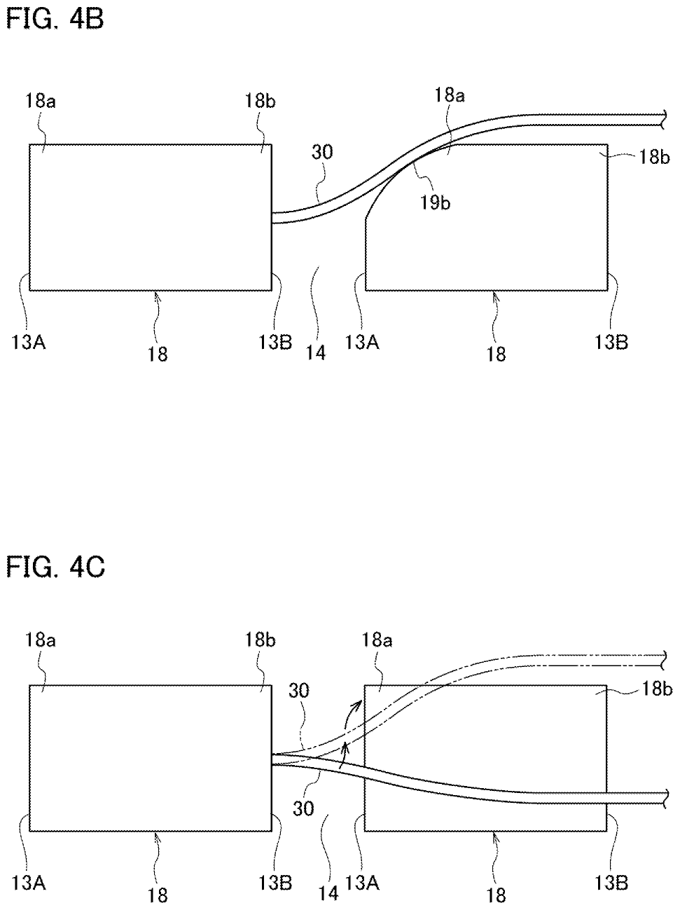

FIG. 1 is a plan view of a bus-bar module according to an embodiment. FIG. 2 is a perspective view of the bus-bar module. FIG. 3 is a perspective view illustrating routing of an electrical-wire in the bus-bar module. FIG. 4A is a schematic side view illustrating the routing of an electrical-wire in the bus-bar module. FIG. 4B is a schematic side view illustrating routing of an electrical-wire in a bus-bar module according to another embodiment. FIG. 4C is a schematic side view illustrating routing of an electrical-wire in a bus-bar module according to a comparative example.

The bus-bar module 10 illustrated in FIG. 1 is assembled into a battery module 1 of a power supply apparatus (not illustrated in the figures) installed in a battery electric vehicle (BEV), which runs by using an electric motor, or in a hybrid electric vehicle (HEV), which runs by utilizing a combination of an engine and an electric motor.

The battery module 1 is configured of plural battery cells 2 that are arranged in a row(s) and fixed to each other. Each of the battery cells 2 is provided with a rectangular battery main body and a pair of electrodes (not illustrated in the figures) that protrude from one end and another end of an upper face of the battery body, respectively. One of the paired electrodes is a positive electrode and another of them is a negative electrode. The battery cells 2 are aligned alternately so that the positive electrode and the negative electrode are made adjacent to each other. The bus-bar module 10 is assembled on one electrode side of the battery cells 2 (on the one electrode side of the four battery cells 2 in the present embodiment) on a top surface of the battery module 1. The bus-bar module 10 is also assembled on another electrode side of the battery cells 2 (on the other electrode side of the four battery cells 2 in the present embodiment). In a case where the battery module 1 is configured of more than four of the battery cells 2, plural bus-bar modules 10 are used.

The bus-bar module 10 includes an electrical-wire routing body 11 to be assembled with the battery module 1, plural bus-bars 20 that are stored in the electrical-wire routing body 11 and are to be electrically connect between electrodes of the battery cells 2, respectively, and plural electrical wires 30 to be connected with the battery cells 2 via the bus-bars 20.

The electrical-wire routing body (case) 11 is made of synthetic resin and has bus-bar storages 12 for storing the bus-bars 20, and electrical-wire routing grooves 13 that serve as electrical-wire routing passages for storing the electrical wires 30, as illustrated in FIG. 1 to FIG. 3. The bus-bar storages 12 and the electrical-wire routing grooves 13 are respectively divided by a slit 14 to absorb pitch tolerance caused by charging and discharging of the battery module 1. The two sets of the bus-bar storage 12 and the electrical-wire routing groove 13 are connected with each other by a hinge 15.

As illustrated in FIG. 1 and FIG. 2, each of the bus-bar storages 12 divided by the slit 14 is formed to have a box shape. A pair of rectangular openings 12b, 12b, through each of which an upper face of the battery cell 2 is exposed, is formed on the bottom wall 12a of the bus-bar storage 12. The rectangular plate-shaped bus-bars 20 are to be stored in the bus-bar storages 12, respectively.

Each of the electrical-wire routing grooves 13 divided by the slit 14 stores the routed electrical wire(s) 30. The electrical-wire routing groove 13 is provided with a bottom wall 16 and a pair of side walls 17, 18 rising from both side edges of the bottom wall 16, respectively. An electrical-wire entry port 13A is formed at one end of the electrical-wire routing groove 13, and an electrical-wire exit port 13B is formed at another end thereof. A rectangular electrical-wire lead-out port 13C is formed in the side wall 17 closer to the bus-bar storage 12 (i.e., located on an inner side) to lead the electrical wire 30 connected to the bus-bar 20 out into the electrical-wire routing groove 13. The electrical-wire lead-out port 13C is closer to the electrical-wire entry port 13A than the electrical-wire exit port 13B.

A tapered cut-off 19A is formed at an upper-end corner 18a of the side wall 18 distanced from the bus-bar storage 12 (i.e., located on an outer side). In other words, the tapered cut-off 19A is formed at the upper-end corner 18a of an outer one of the opposite upper-end corners 17a, 18a of the pair of side walls 17, 18. The cut-off 19A is formed so as to incline straight at the upper-end corner 18a of the side wall 18 located on the outer side at the electrical-wire entry port 13A, as illustrated in FIG. 4A. More specifically, the cut-off 19A is formed straight between a middle of an upper edge of the side wall 18 and a middle of a side edge, which face to the slit 14, of the side wall 18. The cut-off is not limited to be formed straight, but may be formed as a curved cut-off 19b that is made convex outwardly as illustrated in FIG. 4B. In the figures, the signs 17a,18a indicate the upper-end corners of the side walls 17, 18 at the electrical-wire entry port 13A, and the signs 17b, 18b indicate the upper-end corners of the side walls 17, 18 at the electrical-wire exit port 13B. The cut-off 19A illustrated in FIG. 4A is inclined at a 45-degree angle. In the present embodiment, no cut-off is formed at the upper-end corner 18b at the electrical-wire exit port 13B. If a cut-off is also formed at the upper-end corner 18b at the electrical-wire exit port 13B, an upper open width of the slit 14 will be too wide and the electrical wire 30 will easily fall into the slit 14.

As illustrated in FIG. 1 and FIG. 3, the bus-bar 20 is formed from a conductive metal plate to have a rectangular plate shape, and is provided with a pair of round-shaped attachment holes 21, 21 through which the positive and negative electrodes of the adjacent battery cells 2 are inserted, respectively. The pair of attachment holes 21, 21 are distanced from each other at the same distance between the positive and negative electrodes of the adjacent battery cells 2 along the longitudinal direction of the bus-bar 20. The bus-bar 20 is attached to the battery cells 2 by screwing nuts (not illustrated in the figures) onto the positive and negative electrodes inserted through the pair of attachment holes 21, 21, respectively. As a result, the positive and negative electrodes are electrically connected by the bus-bar 20. In other words, the bus-bar 20 is attached to the positive and negative electrodes of the adjacent battery cells 2 in the battery module 1, and thereby the adjacent battery cells 2 are electrically connected in series. In addition, the electrical wire 30 is crimp-connected to an end edge of the bus-bar 20 closer to the electrical-wire routing groove 13 via a joint terminal 22, as illustrated in FIG. 1. Note that a voltage detection terminal (not illustrated in the figures) may be further connected to the end edge of the bus-bar 20 closer to the electrical-wire routing groove 13 and a voltage detection wire crimp-connected to the voltage detection terminal may be routed in the electrical-wire routing groove 13.

As Illustrated in FIG. 1, the electrical wire 30 is connected to the battery cells 2 via the bus-bar 20. The electrical wire 30 is a coated wire having a conductive core wire and an insulation coating covering the core wire. The insulation coating is stripped off at one end 31 of the electrical wire 30, and thereby the core wire is exposed. The one end 31 of the electrical wire 30 is electrically connected to the bus-bar 20 at the above-mentioned joint terminal 22. The other end of the electrical wire 30 is connected to a voltage detection circuit or the like of an ECU (Electronic Control Unit), which is not illustrated in the figures. The ECU detects a remaining capacity, a state of charge/discharge and so on of a battery cell 2 based on a potential difference (voltage) between the pair of electrodes of the battery cell 2 detected by the voltage detection circuit.

According to the bus-bar module 10 in the above embodiment, as illustrated in FIG. 3 and FIG. 4A, even if the electrical wire 30 enters into the slit 14 when routing the electrical wire 30 connected to the bus-bar 20 in the electrical-wire routing groove 13, the electrical wire 30 will slip out upwardly along the tapered cut-off 19A. In other words, as illustrated by an arrow in FIG. 4A, the electrical wire 30 will not get caught in the slit 14 and fall downward, but will return into the electrical-wire routing groove 13. For example, as illustrated in FIG. 4C, if the tapered cut-off 19A is not formed at the outer upper-end corner 18a at the electrical-wire entry port 13A, the electrical wire 30 would be caught in the slit 14 and fall downward and thereby it becomes impossible to route the electrical wire 30 smoothly in a short time. However, in the present embodiment, the electrical wire 30 connected to the bus-bar 20 can be instantly returned from inside the slit 14 to the electrical-wire routing groove 13 by the tapered cut-off 19A at the upper-end corner 18a of the side wall 18 located on the outer side at the electrical-wire entry port 13A. Therefore, it becomes possible to route the electrical wire 30 between the pair of side walls 17, 18 at the electrical-wire entry port 13A in a short time and smoothly without getting the electrical wire 30 caught at the upper-end corner 18a.

In addition, as illustrated in FIG. 4B, even if the electrical wire 30 enters into the slit 14 when routing the electrical wire 30 connected to the bus-bar 20 in the electrical-wire routing groove 13, the electrical wire 30 will slip out upwardly along the curved cut-off 19b. Therefore, it becomes possible to route the electrical wire 30 in a short time and smoothly without getting the electrical wire 30, which is connected to the bus-bar 20, caught in the slit 14 or caught at the upper-end corner 18a of the side wall 18 located on the outer side at the electrical-wire entry port 13A.

Although the present embodiment is described above, the present embodiment is not limited to the above, and various modifications can be made within the scope of the subject matter of the present embodiment.

In other words, the electrical-wire routing body provided with the pair of bus-bar storages is used in the above embodiment. A long electrical-wire routing body, in which plural bus-bar storages are formed on each of both sides of a slit, may be assembled to a battery module. The plural bus-bar storages on the one side and the plural bus-bar storages on the other side are connected by a hinge at the slit.

In the above embodiment, the tapered cut-off is formed at the upper-end corner of the side wall located on the outer side at the electrical-wire entry port. However, a tapered cut-off may be formed at the upper-end corner of the side wall located on the inner side at the electrical-wire entry port.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A bus-bar module comprising:
an electrical-wire routing body to be assembled with a battery module configured of a plurality of battery cells;
a plurality of bus-bars that are stored in the electrical-wire routing body and are to be electrically connected between electrodes of the battery cells, respectively; and
a plurality of electrical-wires to be connected with the battery cells via the bus-bars,
wherein the electrical-wire routing body includes a pair of electrical-wire routing passages that are divided by a slit and in which the electrical-wires are routed,
wherein each of the electrical-wire routing passages is provided with a pair of side walls, and
wherein, in at least one of the pair of electrical-wire routing passages that are divided by the slit, a cut-off is formed at an upper-end corner of one of the pair of side walls, the upper-end corner facing to the slit.

2. The bus-bar module according to claim 1,
wherein the electrical-wire routing body includes a pair of bus-bar storages that store the bus-bars and are divided by the slit, and a pair of electrical-wire routing grooves that store the electrical-wires and are divided by the slit, the pair of electrical-wire routing grooves serving as the pair of electrical-wire routing passages, and
wherein two sets of the bus-bar storage and the electrical-wire routing groove are connected with each other with a hinge interposed the two sets.

3. The bus-bar module according to claim 2,
wherein each of the electrical-wire routing grooves is provided with a bottom wall and the pair of side walls raising from both side edges of the bottom wall, respectively, and
wherein the cut-off is formed at the upper-end corner located on an electrical-wire entering side of the electrical-wire routing groove.

4. The bus-bar module according to claim 3,
wherein the one of the pair of side walls is the side wall located on an outer side.

5. The bus-bar module according to claim 1,
wherein the cut-off is formed straight between a middle of an upper edge of the one of the pair of side walls and a middle of a side edge the one of the pair of side walls, the side edge facing to the slit.

6. The bus-bar module according to claim 1,
wherein the cut-off is formed curvedly to be convex outward between a middle of an upper edge of the one of the pair of side walls and a middle of a side edge the one of the pair of side walls, the side edge facing to the slit.
